(19) United States
(12) Patent Application Publication
(10) Pub. No.: US 2015/0169682 A1
(43) Pub. Date: Jun. 18, 2015

(54) Hash Learning

(71) Applicant: Google Inc., Mountain View, CA (US)

(72) Inventor: Alexander Toshkov Toshev, San Francisco, CA (US)

(73) Assignee: Google Inc., Mountain View, CA (US)

(21) Appl. No.: 14/057,007

(22) Filed: Oct. 18, 2013

(51) Int. Cl. G06F 17/30

(52) U.S. Cl. CPC G06F 17/30442

(57) ABSTRACT

An asymmetric hashing system that hashes query and class labels onto the same space where queries can be hashed to the same binary codes as their labels. The assignment of the class labels to the hash space can be alternately optimized with the query hash function, resulting in an accurate system whose inference complexity that is sublinear to the number of classes. Queries such as image queries can be processed quickly and correctly.

### BACKGROUND

Search queries that include complex items such as images and audio files can return class labels that describe attributes of the queried item. For example, a query that includes an image can return labels such as “car” and “train” that indicate that the query image contains images of a car and train. Complex items can often include a large number of possible attributes and therefore can correspond to any of a large number of candidate labels. For example, the number of possible labels that can be applied to an image is as diverse as the many different things that the image may include. Searching through a vast number of candidate labels to obtain good matches for an image can be expensive in terms of processor power and memory. Further, such an extensive search across labels can take so much time as to make real-time or near real-time searches impractical.

### BRIEF SUMMARY

According to implementations of the disclosed subject matter, a query hash function and a label hash function can be selected that map queries and class labels (respectively) to the same hash space. The class labels can be assigned to hashes in the hash space. The assignment of the class labels to the hash space and the query hash function can be alternately optimized. This may be repeated for different hash functions, thereby generating multiple optimizations for the same hash space. The labels for each hash can be consolidated across the optimizations and a search can be run using the consolidated optimization.

Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows a method according to an implementation of the disclosed subject matter.

### DETAILED DESCRIPTION

An implementation of the disclosed subject matter can efficiently process search queries. The query can be based upon a text input, an image input, an audio input or any other data that can be a suitable basis for a search. The result of the search can include a class label (also referred to simply as a “label”) that can describe an attribute of the query. For example, an implementation can process a query that includes an image and determine that the labels “cat” and “car” correspond to the image, i.e., that the image includes images of a cat and a car. “Cat” and “car” are examples of labels. An implementation of the disclosed subject matter can find the labels corresponding to a query without having to search across all possible labels.

An implementation can use an asymmetric hashing procedure that can hash items from two different spaces into a common space. For example, queries and class labels can be mapped onto the same k-dimensional space of binary codes. A query and its corresponding label can be mapped to the same binary code. Each code can include a short list of candidate class labels for which any suitable pre-trained classifier can be run. The complexity of the hashing functions as well as the number of the resulting labels can be sub-linear in the number of labels and can further be logarithmic. This can enable the scaling of a classification paradigm with linear complexity to a large number of classes.

An implementation can solve a learning problem for the asymmetric hashing to optimize for both hash accuracy as well as search efficiency. The former criterion can maximize the collisions between query hashes and label hashes. The latter criterion can distribute labels substantially uniformly across binary codes. Thus, for a query that is hashed onto a binary code, only a small number of labels need to be taken into account. While hashing all queries and labels onto a single binary code would guarantee perfect accuracy, one would have to score the query with respect to all of the labels. On the other hand, hashing the labels uniformly onto all binary codes might be more efficient, but may not always allow for learning a hash function with high accuracy. Implementations of the disclosed subject matter can reconcile these conflicting requirements by using a process that optimizes for both criteria and can find an optimal balance between accuracy and search efficiency.

Implementations can accommodate a large family of hash functions, at least including all binary classifiers. An implementation can be independent of the choice of classifier for the subsequent classification. This can allow for flexibility and can facilitate the applicability of various implementations of the disclosed subject matter to a wide range of different problems.

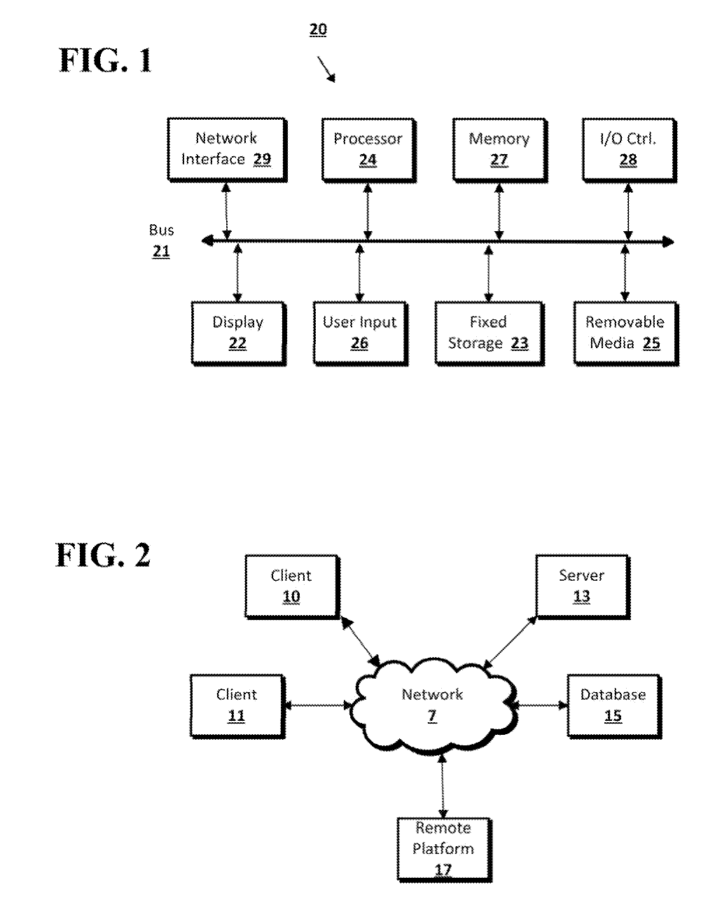

Implementations of the presently disclosed subject matter may be implemented in and used with a variety of component and network architectures. FIG. 1 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., wearable devices, touchscreen devices, music players, document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as thermostats, local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

Consider the problem of multi-way classification where for a given query xε [symbol] ⁿ and a space of labels L, one wants to find the most likely class label for x. The likelihood for a class l can be given by the score of the classifier sₗ(x). Hence the classification can be formulated as the problem of finding the label l* with the highest score:

l*=argmax_{lεL}sₗ(x) Equation (1)

The one-versus-rest classification scheme can be cast in the above form, where sₗ(x) is the score of the one-versus-rest classifier for class l. For example, this can be the margin if the classifier is SVM, the likelihood if we use logistic-regression, the score of a boosting algorithm etc. Further, one can similarly cast schemes where the classifiers are trained jointly. Note that in all of the above cases the classification complexity can be linear in number of labels n=|L|.

The problem may become challenging when L is large such that exhaustive search linear in n is prohibitive. As a classification problem grows, it is common to encounter cases where the label set consists of tens of thousands of labels. In such cases, applying all classifiers at query time can become prohibitively slow. In such cases, algorithms with sublinear complexity in n can become especially valuable.

An implementation can efficiently compute for a given query x a bucket B(x)⊂L of label candidates for which only the original similarity function will be evaluated:

l*=argmax_{lεB(x)}sₗ(x) Equation (2)

A “bucket” can be generated using a hash function, e.g., a function that maps a data point onto a finite space, for example the space of k-dimensional binary codes {−1,1}^{k}. Each binary code can denote a bucket and both terms are used interchangeably herein.

In an implementation, the queries and the labels can be drawn from different spaces and there can be two hash functions. The first can map queries to binary codes

h: [symbol] ⁿ→{−1,1}^{k}

and can assign them to buckets. The second function can map a label to a binary code:

g:L→{−1,1}^{k}.

Note that in the simple case a label can be assigned to a single code, a label can also be assigned to multiple binary codes.

Considering those two hash functions, one can define the bucket of candidate labels for query x as:

B(x;h,g)={lεL|h(x)=g(l)} Equation (3)

where the bucket of x can consist of all labels that are mapped to the same binary code under g as x under h. B(x) can contain the most likely label from L to x with respect to the similarity s₁(•). This can assure that the classification results can be identical to the classification results in the original formulation in Equation (1).

Searching within the elements of the bucket can be done efficiently. Since it can be done by exhaustively computing the original similarity function to all labels in the bucket, this property can be equivalent to having a small bucket. Applying the hash function h to obtain a bucket can also be efficient, i.e., it may be more efficient than linear through L.

In an implementation, a class of hash functions g and h can be defined that can be learned in such a way that the first two properties, correctness and search efficiency, are optimized for the buckets these functions generate. The third property, hash efficiency, can follow from the chosen class of hash functions h.

In particular, for a given set D={(x, l)}, D⊂( [symbol] ⁿ×L), of instances with their best scoring label, an implementation can find hash functions h and g that optimize the following objective:

$$min \frac{1}{\vert D \vert} {\sum }_{( x , l ) ∈ D} L ( B ( x ; h , g ) , l ) + λ R ( h , g ) \qquad Equation ( 4 )$$

Where L(•) can be a loss function that incurs non-zero penalty if the best scoring label is not in the bucket of x and zero otherwise. The second term can incur a penalty if the label buckets are large and this penalty is defined in terms of a regularizer function R( ) that can depend upon the two hash functions.

On a high level, the above objective can ensure that the buckets contain the highest scoring labels for the queries while the bucket size is kept small. The former can correspond to the correctness criterion while the latter can express search efficiency.

To define the first term of Equation (4) that can express the accuracy of the hashing, the loss L can be defined as well as the hash functions g and h. When each label is assigned to exactly one binary code, g can be a mapping from labels to binary codes.

The query hash function h can be defined as a set of k binary functions h=(h₁, . . . , hₖ), hᵢ: [symbol] ⁿ→{−1, 1}. As a hash function, hᵢ can be used to compute the ith dimension of the binary code of the query. Then the corresponding labels can be retrieved through g. However, hᵢ can also be a binary classifier that classifies positively labels whose binary codes have 1 at dimension i, and negatively otherwise. In this process g can translate the original labels from L to binary labels for each hᵢ.

For example, in a hashing space that consists of 3-dimensional binary codes, consider the following three instances:

$$\frac{( \begin{matrix}{h}_{1} \\ {h}_{2} \\ {h}_{3}\end{matrix} )}{Query \\ hashing} \frac{( \begin{matrix}1 \\ - 1 \\ - 1\end{matrix} )}{g ( car )} \frac{( \begin{matrix}1 \\ 1 \\ - 1\end{matrix} )}{g ( bird )} \frac{( \begin{matrix}1 \\ 1 \\ 1\end{matrix} )}{g ( train )}$$

Label car from L has been hashed via g to the first binary label. This label translates to values −1 for hash functions h₂ and h₃ and 1 for h₁. If these hash functions are interpreted as binary classifiers, examples of car can be interpreted to be negative examples for classifiers h₂ and h₃ and a positive one for h₁. Hash function g can be interpreted as providing a partitioning of L into binary splits for each dimension defining a binary classification problem for each hash function. In the above example, all car would be positive for h₂, while bird, cat and train would be negative.

This allows us to formulate a correctness criterion which translates to a learning problem for h and g. Consider a binary loss function L. Then for a given pair of query and label (x, l) we want to incur a small loss if all binary classifiers hᵢ incur a small loss for l being mapped to g(l), where g(l)=(g₁(l), . . . , gₖ(l)). This criterion can be written as a product of negative terms of the loss:

$$L ( B ( x ; h , g ) , l ) = 1 - {\prod }_{i = 1}^{k} ( 1 - L ( {h}_{i} ( x ) , {g}_{i} ( l ) ) ) \qquad Equation ( 5 )$$

If all classifiers incur a loss 0 for a particular label, then the above loss can give value 0. If at least one of the classifiers incurs a non-zero loss, e.g., 1, then the function can have a non-zero value.

To parameterize the above loss we can introduce an indicator variable which relates the binary codes and the labels:

$${t}_{b} = \{ \begin{matrix}1 , & if label l is mapped to binary code b \\ 0 , & otherwise\end{matrix} \qquad Equation ( 6 )$$

Note that this variable completely defines the label hash function g as g(l)=Σ_{bε{0,1}}_{^{k}}t_{b}(l)b, where in the summation the indicator variable will select the code to l.

Using the variables from Equation (6), the loss in Equation (5) can be re-written as:

$$L ( B ( x ; h , t ) , l ) = - {\sum }_{b ∈ {\{ 0 , 1 \}}^{k}} {t}_{b} ( l ) {\prod }_{i = 1}^{k} ( 1 - L ( {h}_{i} ( x ) , {b}_{i} ) ) \qquad Equation 7$$

where we sum over all possible binary codes while considering only these to which the label l has been mapped. Note that we have removed the constant 1.

It will be beneficial to consider a more general formulation of the hashing accuracy criterion where a label can be mapped to multiple binary codes. In this case the label hash g is a mapping to sets of binary codes: g:L→2^{{0,1}}^{^{k}}. Then the correctness criterion from Equation (5) reads:

$$L ( B ( x ; h , g ) , l ) = 1 - {\sum }_{b ∈ ( g , l )} {\prod }_{i = 1}^{k} ( 1 - L ( {h}_{i} ( x ) , {b}_{i} ) )$$

where in the above equation g(l) denotes a set of codes. Note that this extension does not change the parameterized loss in Equation (7). The indicator t naturally accommodates this case.

The criterion from Equation (5) can be related to traditional hashing accuracy measures. Consider the case where L is the 0/1-loss: L(h(x),l)=I(h(x)≠l) having value 1 if the output of the classifier and the label differ, and 0 otherwise. Then the criterion in Equation (5) reads as:

$$L ( l , B ( x ; t , h ) ) = 1 - {\prod }_{i = 1}^{k} I ( {h}_{i} ( x ) = {g}_{i} ( l ) ) = I ( h ( x ) \neq g ( l ) )$$

Hence the first term in Equation (4) can be the empirical expectation of misclassification of an example, or the error rate, by all binary classifier. This value can be understood as a rate, such as the probability of hashing x and the true l in different buckets.

The 0/1-loss is non-convex, so standard losses can be used, which can be truncated so that their image is in [0, 1]. This can assure that individual product terms in Equation (5) are non-negative. More precisely, if one chooses to use SVMs as hash functions, then L would be truncated hinge loss, exponential loss would be inspired by AdaBoost, logistic loss by Logistic Regression, etc. An implementation can use truncated hinge loss, but the disclosed subject matter includes a general formulation that allows for other binary classifiers to be used as hash functions.

The second term in Equation (4) can encourage efficiency when searching within a bucket. One way to express this is in terms of worst search time that can be linear in the size of the largest bucket. In addition can regularize the hash classifiers if they have associated regularization terms R(•):

$$R ( g , h ) = \frac{1}{\vert L \vert} {max}_{b ∈ {\{ 1 , 0 \}}^{k}} \vert \{ l \vert g ( l ) = b \} ] + {\sum }_{i = 1}^{k} R ( {h}_{i} ) \qquad Equation ( 8 )$$

The first term can measure the normalized size of the largest bucket expressed in terms of the label hash function g. The second term can be the sum of the regularizers of the classifiers hᵢ. For example, if the hash function is inspired by a L2-regularized SVM, then R(hᵢ) can be the L2 norm of the parameter vector of hᵢ.

The bucket to label indicator variable in Equation (6) can be used to express the size of a particular bucket bε{0, 1}^{k} as Σₗt_{b}(l). Thus the regularizer reads:

$$R ( t , h ) = {max}_{b ∈ {\{ 0 , 1 \}}^{k}} \frac{1}{\vert L \vert} {\sum }_{l} {t}_{b} ( l ) + {\sum }_{i = 1}^{k} R ( {h}_{i} ) \qquad Equation ( 9 )$$

Using the parameterizations from Equation (7) and Equation (9) allow the definition of an optimization problem solving Equation (4):

$$\begin{matrix}{min}_{t , \{ {h}_{j} \}} \frac{1}{\vert D \vert} {\sum }_{( x , l )} L ( B ( x ; t , h ) , l ) + λ R ( t , h ) & Equation 10 \\ ∋ {t}_{b} ( l ) ∈ \{ 0 , 1 \} , 1 \leq {\sum }_{b} {t}_{b} ( l ) \leq A & Equation ( 11 )\end{matrix}$$

where A is the maximum number of binary codes to which a label can be assigned. The first constraint can ensure that the variable t is an indicator variable, while the second constraint can ensure that each label l is assign to at most A buckets.

To solve the above problem, we relax the domain of t to [0, 1] and introduce an auxiliary variable ζ to upper bound the bucket size:

$$\begin{matrix}{min}_{t , \{ {h}_{j} \} , ξ} \frac{1}{\vert D \vert} {\sum }_{( x , l )} L ( B ( x ; t , h ) , l ) + λ R ( t , h ) + ξ & Equation ( 12 ) \\ ∋ {t}_{b} ( l ) ∈ \{ 0 , 1 \} , 1 \leq {\sum }_{b} {t}_{b} ( l ) \leq A & Equation ( 13 ) \\ {\sum }_{l} {t}_{b} ( l ) \leq ξ for all b ∈ {\{ 0 , 1 \}}^{k} & Equation ( 14 )\end{matrix}$$

Optimizing over both the classifier parameters and the indicator variables t can be achieved by decoupling this problem into a sequence of optimization problems, where we can solve for the label-to-binary-code assignment t first and then we can optimize the parameters of the hash functions hⱼ. We can iterate between the two optimizations until convergence.

If the parameters of the classifiers are fixed, then the objective of the above optimization translates to:

$${max}_{t , ξ} {\sum }_{b , l} ( {\sum }_{( x , {l}^{′} ) ∈ D \\ {l}^{′} = l} {\prod }_{i = 1}^{k} ( 1 - L ( {h}_{i} ( x ) , {b}_{i} ) ) ) {t}_{b} ( l ) + ξ \qquad Equation ( 15 )$$

subject to the same constraints, where for each pair of binary code and label we can use the examples assigned to this label to define the weight to the corresponding assignment variable. This weight can be large if there are many examples with the same label for which losses of the individual hash functions are zero or close to zero. Such label to bucket assignments can be preferred since it means that assigning the l to the b can be supported by the currently trained h. This problem can be an instance of linear programming and can be solved exactly.

If the assignment variables t and the parameters of all classifiers except of the jth one are fixed, then the optimization becomes:

$${min}_{{w}_{j}} {\sum }_{( x , l ) \\ b} {t}_{b} ( l ) {\prod }_{i \neq j} ( 1 - L ( {h}_{j} ( x ) , {b}_{i} ) ) L ( {h}_{j} ( x ) , {b}_{j} ) + R ( {w}_{j} ) \qquad Equation ( 16 )$$

Intuitively, the above objective corresponds to optimizing the binary classifier hⱼ over examples {(x, bⱼ)|(x, l)εD and t_{b}(l)=1}, i.e., the original examples can be assigned a binary label based on their original label and to which binary code this original label has been assigned. The ith dimension of this binary code can provide the binary label.

There are, however, two aspects in which the above loss may differ from the standard learning of a binary classifier. First, the losses can be weighted based on the performance of the other binary classifiers. If at least one of the other binary classifiers performs poorly, then the weight could be low, which means that the current classifier may not try to learn this example. The intuition is that if at least one of the already learned classifiers cannot assign the example to the binary code dimension bᵢ that was given via the original label l and the assignment of this label to codes, then the best strategy could be to reassign the label l to another code which can be learned by all binary classifiers. This can happen in the other step of the optimization.

An implementation of the optimization procedure can start with a label hash function g, which translates to a variable t via Equation (6). We can generate such a hash by randomly assigning L/2^{k} labels to each binary code. This corresponds to an initialization where labels are uniformly distributed across the codes. If one translates this initialization of g to the variable t, it can be seen that in the first step one could optimize for classifiers hᵢ such that the positive and negative sets for each classifier are about equally sized and maximally disjoint to the positive and negative sets of the other classifiers.

An implementation of the optimization procedure is given in Algorithm 1:

```
Input: Examples D = {(x, l)}; hash dimension k.
Output: Hash pair (h, g) ← φ.
Initialize g randomly; initialize t from g using Equation (6).
while objective decrease ≧ ε do
  Solve for t by Linear Program (15)
  for all j = 1 → k do
    Solve for classifier hⱼ using Program (16)
  end for
end while
Set g using current t by Equation (6).
```

After the initial relaxation we can iterate between a linear program and standard binary classifier learning. Note that we can learn the binary classifiers sequentially where the problem for each classifier can be defined by the label-to-binary-code assignment estimated in the first part of the current iteration and the already trained classifiers at the same iteration.

Solving the optimization problem represented by Equation (4) for a binary hash of dimension k may in some cases not be sufficient to achieve satisfactory recall. To see this, consider the miss rate interpretation of the hash loss in Equation (4). If one denotes by p the error rate of a single binary classifier, then the miss rate of a has based on k such classifiers is as 1−(1−p)^{k}. For realistic values of p=0.9 and k=8, one arrives at an error rate (or miss rate) of 0.56.

To deal with this amplified error rate resulting from conjunction of the binary classifier, we can learn a batch of s hashes (H, G)={(h¹, g¹), . . . , (h^{s}, g^{s})}. The resulting bucket can be defined as the union of the buckets given by each hash: B(x; H, G)=∪ᵢ₌₁^{i=s}B(x; hⁱ, gⁱ). An implementation of the learning algorithm is presented in Algorithm 2:

```
Input: Examples D = {(x, l)}; hash dimension k; number of
hashes s in batch.
Output: Hash Batch (H, G) ← φ.
for all i = 1 → s do
  (hⁱ, gⁱ) ← HashLearning(D, k) (Algorithm 1)
  (H, G) ← (H, G) U{(hⁱ, gⁱ)}
end for
```

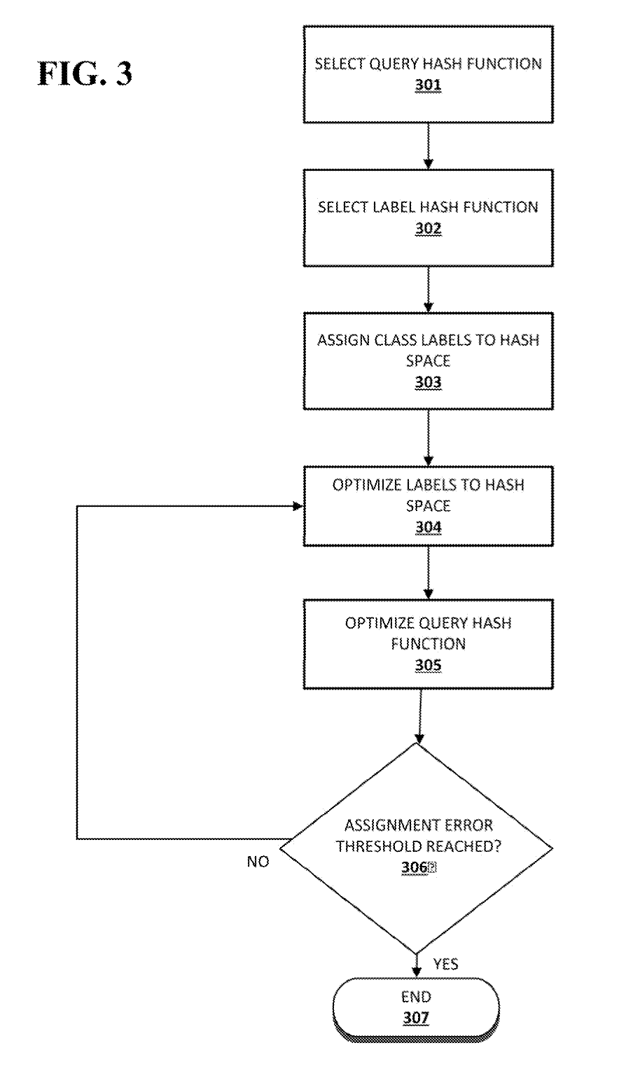

A method according to an implementation of the disclosed subject matter is shown in FIG. 3. A query hash function can be selected, 301, as is a label hash function, 302. Class labels can be assigned to the query space, 303. The labels to the hash space can be optimized, 304, alternately with the query hash function, 305. If an assignment error threshold has not been reached, 306, the process can be repeated. Otherwise, the process can end, 307.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method, comprising:
selecting a first query hash function that maps a plurality of queries to a hash space;
selecting a first label hash function that maps a plurality of class labels to the hash space;
assigning the plurality of class labels to the hash space based on the first label hash function; and
alternately optimizing the assignment of the plurality of class labels to the hash space and the query hash function to comprise a first optimization.

2. The method of claim 1, further comprising:
selecting a second query hash function that maps the plurality of queries to the hash space;
selecting a second label hash function that maps class labels to the hash space; and
alternately optimizing the assignment of the class labels to the hash space and the second query hash function to comprise a second optimization.

3. The method of claim 2, further comprising:
determining a first class label for a hash in the first optimization;
determining a second class label for the hash in the second optimization; and
assigning the first class label and the second class label to the hash to comprise a batch optimization.

4. The method of claim 3, further comprising:
receiving a query;
mapping the query to a hash in the hash space; and
determining a class label that is assigned to the hash in the batch optimization.

5. The method of claim 1, wherein the hash space is a k-dimensional binary space.

6. The method of claim 1, wherein the class label corresponds to at least one property of at least one from the group consisting of an image, an audio and a video.

7. The method of claim 1, wherein the assigning the class labels to hashes in the hash space comprises randomly assigning class labels to hashes in the hash space.

8. The method of claim 1, wherein optimizing the assignment of labels to the hash space comprises minimizing the number of class labels that are a best match to a query and that are not assigned to the hash corresponding to the query.

9. The method of claim 1, further comprising minimizing the number of class labels that are a best match to a query and that are not assigned to the hash corresponding to the query below an assignment error threshold.

10. The method of claim 9, further comprising determining that the assignment error threshold has been reached using a linear program.

11. The method of claim 1, further comprising optimizing the first query hash function using a learning program.

12. A system, comprising:
a memory;
a processor in communication with the memory, the processor configured to:
select a first query hash function that maps a plurality of queries to a hash space;
select a first label hash function that maps a plurality of class labels to the hash space;
assign the plurality of class labels to the hash space based on the first label hash function; and
alternately optimize the assignment of the plurality of class labels to the hash space and the query hash function to comprise a first optimization.

13. The system of claim 12, wherein the processor is further configured to:
select a second query hash function that maps the plurality of queries to the hash space;
select a second label hash function that maps class labels to the hash space; and
alternately optimize the assignment of the class labels to the hash space and the second query hash function to comprise a second optimization.

14. The system of claim 13, wherein the processor is further configured to:
determine a first class label for a hash in the first optimization;
determine a second class label for the hash in the second optimization; and
assign the first class label and the second class label to the hash to comprise a batch optimization.

15. The system of claim 14, wherein the processor is further configured to:
receive a query;
map the query to a hash in the hash space; and
determine a class label that is assigned to the hash in the batch optimization.

16. The system of claim 12, wherein the hash space is a k-dimensional binary space.

17. The system of claim 12, wherein the class label corresponds to at least one property of at least one from the group consisting of an image, an audio and a video.

18. The system of claim 12, wherein the processor is further configured to randomly assign class labels to hashes in the hash space.

19. The system of claim 12, wherein the processor is further configured to minimize the number of class labels that are a best match to a query and that are not assigned to the hash corresponding to the query.

20. The system of claim 12, wherein the processor is further configured to minimize the number of class labels that are a best match to a query and that are not assigned to the hash corresponding to the query below an assignment error threshold.

21. The method of claim 20, wherein the processor is further configured to determine that the assignment error threshold has been reached using a linear program.

22. The method of claim 12, wherein the processor is further configured to optimize the first query hash function using a learning program.
